(19) United States
(12) Patent Application Publication
(10) Pub. No.: US 2012/0271439 A1
(43) Pub. Date: Oct. 25, 2012

(54) MACHINE DISPLACEMENT ADJUSTMENT SYSTEM FOR MACHINE TOOLS

(75) Inventor: Hideaki Yamamoto, Minato-ku (JP)

(73) Assignee: MITSUBISHI HEAVY INDUSTRIES, LTD., Tokyo (JP)

(21) Appl. No.: 13/504,914

(22) PCT Filed: Sep. 15, 2010
(86) PCT No.: PCT/JP2010/065911

§ 371 Date: Jul. 12, 2012

(30) Foreign Application Priority Data
Jan. 8, 2010 (JP) 2010-002631

(51) Int. Cl. G05B 15/02

(52) U.S. Cl. 700/73

(57) ABSTRACT

Provided is a machine displacement adjustment system for machine tools, which uses a tilt angle detector, such as a level, which can directly detect the tilt angle of a machine structure, such as a column. Said system is provided with: a tilt angle detector (a level) which is disposed on a machine tool structure, detects the tilt angle of said structure, and outputs data of the tilt amount; and an adjustment device (92) which has a tilt amount data inputting unit (93) for inputting the aforementioned data of the tilt amount (c1 to c6) obtained from the tilt angle detector, a machine displacement amount calculating unit (94) for calculating the machine displacement amount of the aforementioned structure on the basis of the data of the tilt amount (c1 to c6) inputted by means of the tilt amount data inputting unit, and an adjustment amount calculating unit (95) for calculating the adjustment amount of the displacement axes (X axis, Y axis, and Z axis) of the machine tool on the basis of the machine displacement amount of the structure calculated by means of the machine displacement amount calculating unit.

### TECHNICAL FIELD

The present invention relates to a machine displacement correction system for correcting machine displacement (thermal displacement, self-weight displacement, level displacement) of a machine tool.

### BACKGROUND ART

In general, a full closed-loop feedback control system as shown in FIG. 7 is employed in a servo control device performing positioning control of a machine tool. Although a specific description is omitted herein, the servo control device shown in FIG. 7 performs positioning control in a way that makes the position of a moving body 1 follow a position command by controlling the rotation of a servomotor 3 on the basis of position feedback information (i.e., machine end position information) from a position detector 2, which is provided to the moving body 1, and velocity feedback information to be fed back via a differential operation unit 5 from a pulse coder 4, which is provided to the servomotor 3. Incidentally, Kp denotes the position loop gain, Kv denotes the velocity loop proportional gain, Kvi denotes the velocity loop integral gain and s denotes the Laplace operator in FIG. 7.

As described above, the full closed-loop feedback control system uses the machine end position information as the position feedback information. However, when machine displacement occurs in each structure of a machine tool due to a temperature change in heat sources such as a main spindle and the servomotor 3 included in the machine tool, and due to a temperature change in the outside air, static accuracy such as positioning accuracy of each moving axis in the machine tool or positioning accuracy of a tool in a three-dimensional space is degraded. The machine displacement occurs not only due to thermal displacement, but also due to deflection caused by self-weight, deflection of a structure caused by level displacement, and the like.

Moreover, in a case where a semi closed-loop feedback control system as shown in FIG. 8 is employed as a control system of a machine tool, the static accuracy tends to degrade even more because position information on the servomotor 3 (a rotation angle of the servomotor 3 that is detected by the pulse coder 4) is used as the position feedback information. Note that such machine displacement occurs similarly in control of a robot or the like.

The degradation in the static accuracy due to such machine displacement, particularly, the degradation in the static accuracy due to machine displacement occurring due to heat or the like is a large factor in an increase in machining error, and is still a large problem today. As a measure for the degradation in the static accuracy, provision of a thermal displacement correction system to a control system for a machine tool has been known. With a temperature sensor embedded in the machine, the thermal displacement correction system estimates a thermal displacement amount of the machine by using a simple arithmetic expression on the basis of the temperature data, and thus compensates the machine displacement amount by shifting a machine coordinate or the like by the displacement amount. A specific example of the thermal displacement correction system is shown in FIG. 9 and FIG. 10.

FIG. 9 shows a case of a horizontal machining center. Here, temperature sensors 23-1 to 23-10 are installed to a bed 11, a column 12, a saddle 13 movable in an X-axis direction, ahead 14 provided with a main spindle 25 and movable in a Z-axis direction, a table 15 movable in a Y-axis direction and a workpiece W, which is placed on the table 15. The temperature sensors 23-1 to 23-10 detect the temperatures of the corresponding structures (the bed 11, the column 12, the saddle 13, the head 14, and the table 15) and the workpiece W, and then output temperature data sets (temperature detection signals) a1 to a10.

A correction device 24 includes a temperature data receiving unit 16, a thermal displacement amount calculating unit 17 and a correction amount calculating unit 18. The temperature data receiving unit 16 receives the temperature data sets a1 to a10 from the temperature sensors 23-1 to 23-10. The thermal displacement amount calculating unit 17 calculates the displacement amounts of the structures (the bed 11, the column 12, the saddle 13, the head 14 and the table 15) and the workpiece W due to heat on the basis of the temperature data sets a1 to a10 received by the temperature data receiving unit 16. The correction amount calculating unit 18 calculates the displacement amounts of the moving axes (the X-axis, the Y-axis and the Z-axis) on the basis of the thermal displacement amounts of the structures (the bed 11, the column 12, the saddle 13, the head 14 and the table 15) and the workpiece W calculated by the thermal displacement amount calculating unit 17. The correction amount calculating unit 18 then sets the values of these displacement amounts with a reversed sign as the correction amounts of the moving axes (the X-axis, the Y-axis and the Z-axis), and sends the correction amounts to servo control devices 19, 20, 21 of the respective moving axes (the X-axis, the Y-axis and the Z-axis).

In the servo control device 19 of the X-axis, a deviation operation unit 22 corrects an X-axis position command by adding the correction amount of the X-axis (=“a minus displacement amount of the X-axis”) calculated by the correction amount calculating unit 18 to the X-axis position command, and performs arithmetic on a deviation between the corrected X-axis position command and X-axis position feedback information. In the servo control device 20 of the Y-axis, a deviation operation unit 22 corrects a Y-axis position command by adding the correction amount of the Y-axis (=“a minus displacement amount of the Y-axis”) calculated by the correction amount calculating unit 18 to the Y-axis position command, and performs arithmetic on a deviation between the corrected Y-axis position command and Y-axis position feedback information. In the servo control device 21 of the Z-axis, a deviation operation unit 22 corrects a Z-axis position command by adding the correction amount of the Z-axis (=“a minus displacement amount of the Z-axis”) calculated by the correction amount calculating unit 18 to the Z-axis position command, and performs arithmetic on a deviation between the corrected Z-axis position command and Z-axis position feedback information.

FIG. 10 shows a case of a portal machining center. Here, temperature sensors 45-1 to 45-8 are installed to a bed 31, a gate-shaped column 32, a ram 35 in which a main spindle 36 is incorporated, a table 37, and a workpiece W, which is placed on the table 37. The temperature sensors 45-1 to 45-8 detect the temperatures of the corresponding structures (the bed 31, the column 32, the ram 35 and the table 37) and the workpiece W, and then output temperature data sets (temperature detection signals) b1 to b8 Note that the table 37 is movable in an X-axis direction, a saddle 34 is movable in a Y-axis direction along a cross rail 33, and the ram 35 (the main spindle 36) is movable in a Z-axis direction.

A correction device 46 includes a temperature data receiving unit 38, a thermal displacement amount calculating unit 39 and a correction amount calculating unit 40. The temperature data receiving unit 38 receives the temperature data sets b1 to b8 from the temperature sensors 45-1 to 45-8. The thermal displacement amount calculating unit 39 calculates the displacement amounts of the structures (the bed 31, the column 32, the ram 35 and the table 37) and the workpiece W due to heat on the basis of the temperature data sets b1 to b8 received by the temperature data receiving unit 38. The correction amount calculating unit 40 calculates the displacement amounts of the moving axes (the X-axis, the Y-axis and the Z-axis) on the basis of the thermal displacement amounts of the structures (the bed 31, the column 32, the ram 35 and the table 37) and the workpiece W calculated by the thermal displacement amount calculating unit 39. The correction amount calculating unit 40 then sets the values of these displacement amounts with a reversed sign as the correction amounts of the moving axes (the X-axis, the Y-axis and the Z-axis), and sends the correction amounts to servo control devices 41, 42 and 43 of the respective moving axes (X-axis, Y-axis and Z-axis).

In the servo control device 41 of the X-axis, a deviation operation unit 44 corrects an X-axis position command by adding the correction amount of the X-axis (=“a minus displacement amount of the X-axis”) calculated by the correction amount calculating unit 40 to the X-axis position command, and performs arithmetic on a deviation between the corrected X-axis position command and X-axis position feedback information. In the servo control device 42 of the Y-axis, a deviation operation unit 44 corrects a Y-axis position command by adding the correction amount of the Y-axis (=“a minus displacement amount of the Y-axis”) calculated by the correction amount calculating unit 40 to the Y-axis position command, and performs arithmetic on a deviation between the corrected Y-axis position command and Y-axis position feedback information. In the servo control device 43 of the Z-axis, a deviation operation unit 44 corrects a Z-axis position command by adding the correction amount of the Z-axis (=“a minus displacement amount of the Z-axis”) calculated by the correction amount calculating unit 40 to the Z-axis position command, and performs arithmetic on a deviation between the corrected Z-axis position command and Z-axis position feedback information.

Patent Documents 1 to 5 given below can be cited as prior art documents related to the above-described thermal displacement correction system using the temperature sensors.

### PRIOR ART DOCUMENT

### Patent Documents

Patent Document 1: Japanese Patent Application Publication No. Hei 10-6183
Patent Document 2: Japanese Patent Application Publication No. 2006-281420
Patent Document 3: Japanese Patent Application Publication No. 2006-15461
Patent Document 4: Japanese Patent Application Publication No. 2007-15094
Patent Document 5: Japanese Patent Application Publication No. 2008-183653
Patent Document 6: Japanese Patent Application Publication No. 2007-175818
Patent Document 7: Japanese Patent Application Publication No. Hei 11-226846

### SUMMARY OF THE INVENTION

### Problem to be Solved by the Invention

The number of the temperature sensors used for the estimation of the thermal displacement amount of a machine is limited, however. Thus, it is difficult to completely figure out the thermal displacement amount of the machine. In addition, because the conventional method finds the thermal displacement mode and the thermal displacement amount of the machine by estimation from the detection values of the temperature sensors, the thermal displacement cannot be completely compensated.

Meanwhile, for the purpose of setting the thermal displacement of a machine as a straightforward thermal displacement mode as much as possible, the invention as recited in Patent Document 6 given above or the like has been proposed. However, it is difficult to set the thermal displacement of the machine that is caused by a change in the temperature of the outside air as a completely straightforward thermal displacement mode (i.e., as only a stretch and contraction mode eliminating warpage, tilt or the like of a column or the like). It is difficult to completely eliminate the warpage or tilt of the column or the like that is caused by a change in the temperature of the outside air or the like.

Accordingly, the present invention has been made in view of the aforementioned circumstance, and aims to provide a machine displacement correction system for machine tools that uses a tilt angle detector such as a level capable of directly detecting a tilt angle of a structure of a machine, such as a column.

Note that although an invention that uses levels is proposed in Patent Document 7 given above, this invention relates to a posture control system that uses levels and piezoelectric actuators in combination. Accordingly, this system is not a system configured to correct machine displacement, and deviates from the object of the present invention.

### Means for Solving the Problems

A machine displacement correction system for a machine tool of a first invention for solving the foregoing problem is a machine displacement correction system configured to correct machine displacement of a machine tool. The system comprises:

a tilt angle detector installed to a structure of the machine tool, and configured to detect a tilt angle of the structure and to output tilt amount data; and

a correction device including:
a tilt amount data receiving unit configured to receive the tilt amount data from the tilt angle detector;
a machine displacement amount calculating unit configured to calculate a machine displacement amount of the structure on the basis of the tilt amount data received by the tilt amount data receiving unit; and
a correction amount calculating unit configured to calculate a correction amount of a moving axis of the machine tool on the basis of the machine displacement amount of the structure calculated by the machine displacement amount calculating unit.

In addition, a machine displacement correction system for a machine tool of a second invention is a machine displacement correction system configured to correct machine displacement of a machine tool. The system comprises:

a tilt angle detector installed to a structure of the machine tool, and configured to detect a tilt angle of the structure and to output tilt amount data;

a temperature sensor installed to a structure of the machine tool or a workpiece, and configured to detect a temperature of the structure or the workpiece and to output temperature data; and

a correction device including:
a tilt amount data receiving unit configured to receive the tilt amount data from the tilt angle detector;
a machine displacement amount calculating unit configured to calculate a machine displacement amount of the structure on the basis of the tilt amount data received by the tilt amount data receiving unit;
a first correction amount calculating unit configured to calculate a first correction amount of a moving axis of the machine tool on the basis of the machine displacement amount of the structure calculated by the machine displacement amount calculating unit;
a temperature data receiving unit configured to receive the temperature data from the temperature sensor;
a thermal displacement amount calculating unit configured to calculate a thermal displacement amount of the structure or the workpiece on the basis of the temperature data received by the temperature data receiving unit;
a second correction amount calculating unit configured to calculate a second correction amount of the moving axis on the basis of the thermal displacement amount of the structure or the workpiece calculated by the thermal displacement amount calculating unit; and
a correction amount adder configured to add the first correction amount calculated by the first correction amount calculating unit and the second correction amount calculated by the second correction amount calculating unit.

### Effects of the Invention

The machine displacement correction system for a machine tool according to the first invention is capable of directly figuring out the tilt amount (tilt angle) of the structure of the machine tool with the tilt angle detector (a level, for example) when the structure of the machine tool is inclined due to machine displacement such as warpage and tilt (thermal displacement, self-weight displacement, or level displacement, or a mixture of thermal displacement, self-weight displacement and level displacement). Thus, the machine displacement correction system is capable of estimating the machine displacement amount of the structure with high accuracy by calculating the machine displacement amount of the structure on the basis of the tilt amount data on the structure that is directly figured out by the tilt angle detector. Accordingly, the machine displacement correction system is capable of obtaining the correction amount of the moving axis with high accuracy on the basis of the machine displacement amount. For this reason, a highly-accurate compensation system can be realized.

As in the case of the first invention, the machine displacement correction system for a machine tool according to the second invention is capable of directly figuring out the tilt amount (tilt angle) of the structure of the machine tool with the tilt angle detector (a level, for example) when the structure of the machine tool is inclined due to machine displacement such as warpage and tilt (thermal displacement, self-weight displacement, or level displacement, or a mixture of thermal displacement, self-weight displacement and level displacement). Thus, the machine displacement correction system is capable of estimating the machine displacement amount of the structure with high accuracy by calculating the machine displacement amount of the structure on the basis of the tilt amount data on the structure that is directly figured out by the tilt angle detector. Accordingly, the machine displacement correction system is capable of obtaining the first correction amount of the moving axis with high accuracy on the basis of the machine displacement amount.

Moreover, the second invention makes it possible to deal with not only the machine displacement such as warpage and tilt, but also the thermal displacement such as stretch of the structure and stretch of the workpiece due to heat, because the second correction amount of the moving axis that is found on the basis of the temperature data from the temperature sensor is added to the first correction amount of the moving axis. Accordingly, the second invention makes it possible to obtain the correction amount of the moving axis with higher accuracy. Thus, the second invention can realize a highly-accurate compensation system.

### BRIEF DESCRIPTION OF THE DRAWINGS

FIG. 1 is a diagram relating to a machine displacement correction system using levels according to Embodiment 1 of the present invention, and is a perspective view of a machine tool (portal machining center) showing the arrangement of the levels.

FIG. 2 is a diagram relating to the machine displacement correction system using the levels according to Embodiment 1 of the present invention, and is the diagram showing a configuration of a correction device.

FIG. 3 is a diagram showing an example of calculating an amount of machine displacement attributable to a tilt.

FIG. 4 is a diagram relating to a machine displacement correction system using levels according to Embodiment 2 of the present invention, and is a perspective view of a machine tool (portal machining center) showing the arrangement of the levels.

FIG. 5 is a diagram relating to the machine displacement correction system using the levels according to Embodiment 2 of the present invention, and is the diagram showing a configuration of a correction device.

FIG. 6 is a diagram showing an example of calculating an amount of thermal displacement attributable to a temperature change.

FIG. 7 is a block diagram showing a configuration of a full closed-loop servo control device (feedback control system).

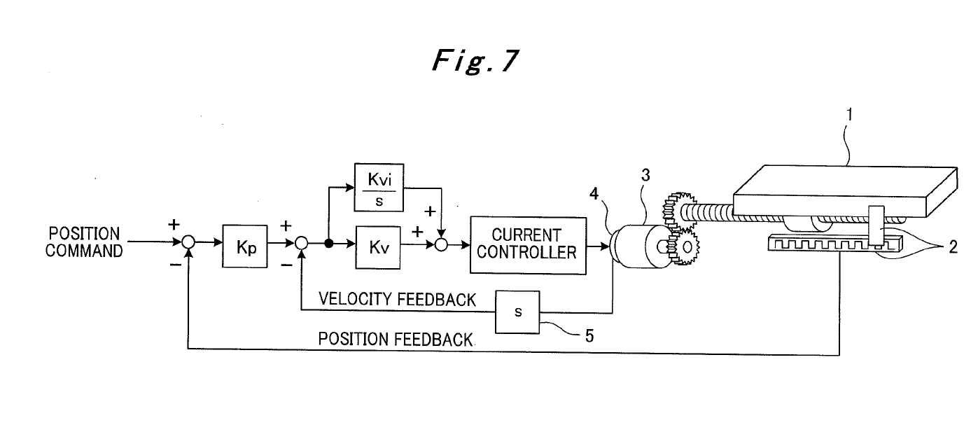

FIG. 8 is a block diagram showing a configuration of a semi closed-loop servo control device (feedback control system).

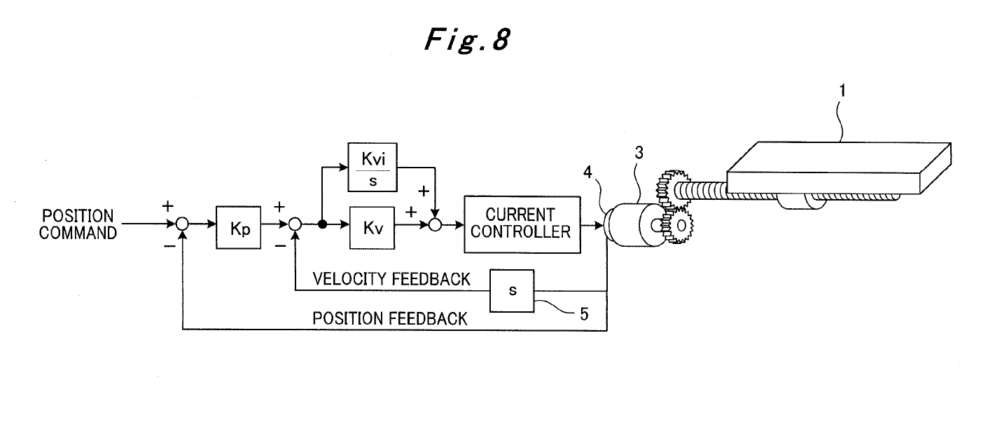

FIG. 9 is a diagram showing a configuration example of a conventional thermal displacement correction system using temperature sensors.

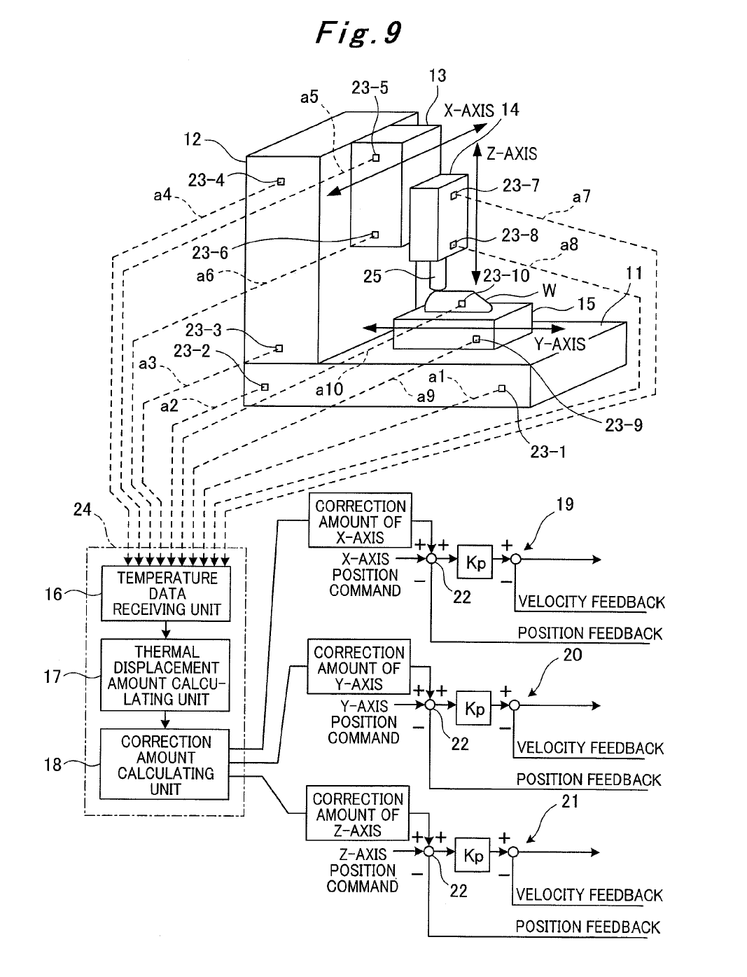

FIG. 10 is a diagram showing another configuration example of the conventional thermal displacement correction system using temperature sensors.

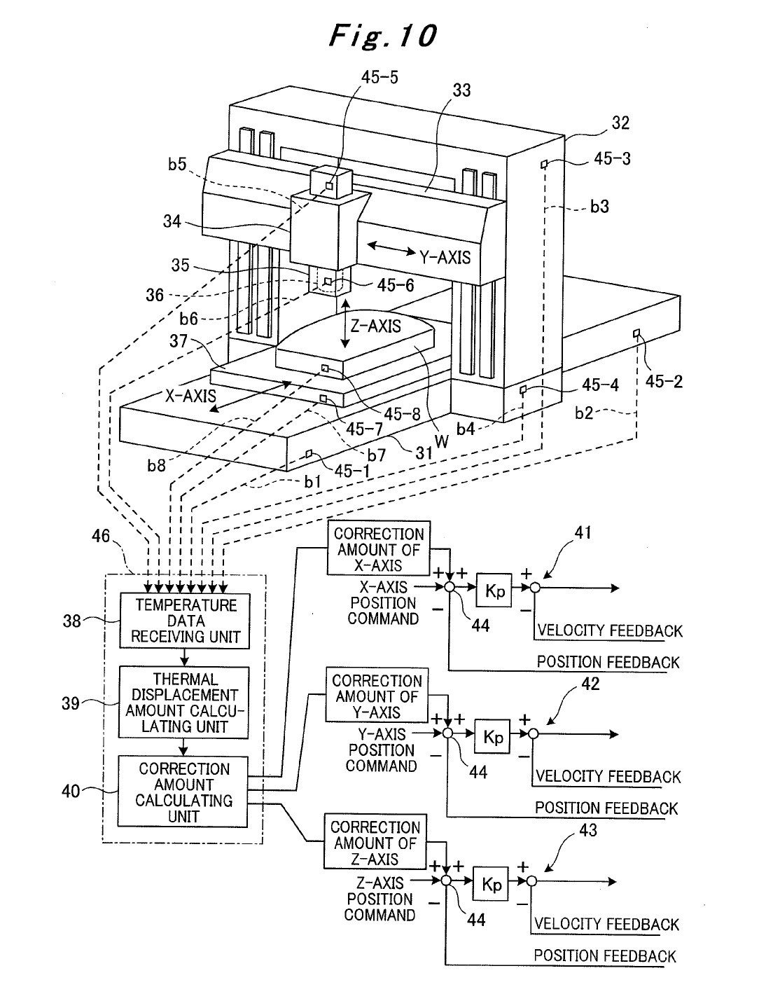

### MODES FOR CARRYING OUT THE INVENTION

Hereinafter, embodiments of the present invention will be described in detail on the basis of the drawings.

### First Embodiment

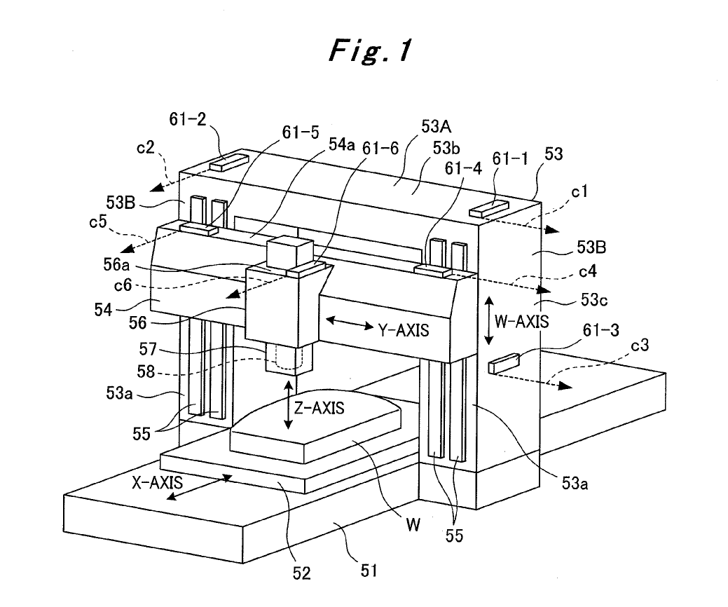

First, a machine displacement correction system using levels according to Embodiment 1 of the present invention will be described on the basis of FIG. 1 to FIG. 3.

As shown in FIG. 1, a machine tool (portal machining center in the illustrated example) includes a bed 51, a table 52, a column 53, a cross rail 54, a saddle 56, and a ram 57 in which a main spindle 58 is incorporated.

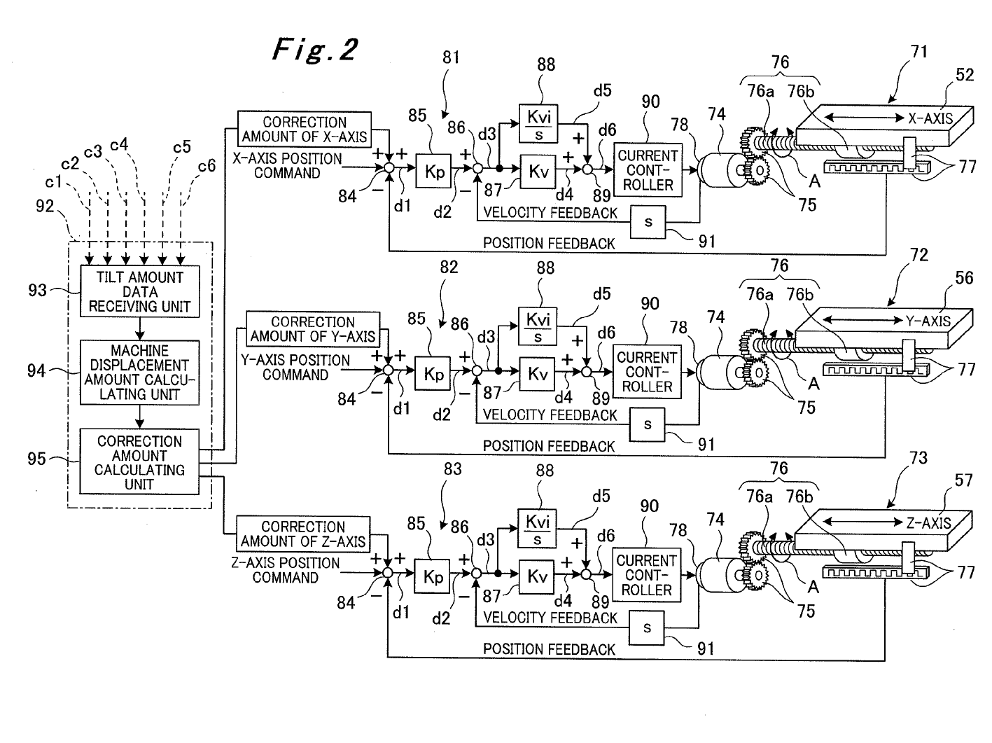

The table 52 is installed on the bed 51, and a workpiece W is placed on the table 52. The table 52 is configured to be movable in a horizontal X-axis direction by a feeding mechanism (whose illustration is omitted in FIG. 1: refer to FIG. 2). The column 53 is shaped like a gate, and includes a horizontal portion 53A and leg portions 53B formed respectively at two sides of the horizontal portion 53A, as well as is installed in such a manner as to stride over the bed 51. The cross rail 54 is provided in front of the column 53, and is configured to be movable along guide rails 55, which are provided to front surfaces 53a of the column 53, in a vertical W-axis direction by a feeding mechanism (whose illustration is omitted). The saddle 56 is provided to the front of the cross rail 54, and is configured to be movable along the cross rail 54 in a horizontal Y-axis direction by a feeding mechanism (whose illustration is omitted in FIG. 1: refer to FIG. 2). The ram 57 is provided in the saddle 56, and is configured to be movable in a vertical Z-axis direction by a feeding mechanism (whose illustration is omitted in FIG. 1: refer to FIG. 2). Note that the X, Y and Z axes are orthogonal to one another.

In addition, digital levels 61-1 to 61-6 are provided in the machine tool. The levels 61-1, 61-2 are installed respectively at two end portions of an upper surface 53b of the column 53, as well as detect tilt angles of the column 53 that are caused by machine displacement of the column 53, and then output tilt amount data sets (tilt angle detection signals) c1, c2, respectively, to a correction device 92 (refer to FIG. 2: which will be described later in detail).

The machine displacement includes thermal displacement, self-weight displacement, level displacement and the like. The thermal displacement is a type of machine displacement such as warpage occurring on a structure because of a temperature difference between the front and back or the left and right of the structure such as the column 53 due to a temperature change in a heat source such as the main spindle 58 or a servomotor (whose illustration is omitted in FIG. 1: refer to FIG. 2), or due to a temperature change in the outside air. The self-weight displacement is another type of machine displacement such as warpage or tilt of a structure caused by its own weight of the structure. The level displacement is yet another type of machine displacement such as warpage or tilt of a structure that occurs due to a change in a level (foundation) where the bed 51 is installed. Accordingly, the tilt of a structure such as the column 53 due to the machine displacement includes the tilt due to the thermal displacement, the tilt due to the self-weight displacement, the tilt due to the level displacement, and the tilt due to a mixture of the thermal displacement, the self-weight displacement and the level displacement.

The level 61-3 is installed at an intermediate height position of a side surface 53c of the column 53, as well as detects a tilt angle of the column 53 that is caused by machine displacement of the column 53, and then outputs a tilt amount data set (tilt angle detection signal) c3 to the correction device 92. The levels 61-4, 61-5 are installed respectively at two end portions of an upper surface 54a of the cross rail 54, as well as detect tilt angles of the cross rail 54 that are caused by machine displacement of the cross rail 54, and then output tilt amount data sets (tilt angle detection signals) c4, c5, respectively, to the correction device 92. The level 61-6 is installed on an upper surface 56a of the saddle 56, as well as detects a tilt angle of the saddle 56 that is caused by machine displacement of the saddle 56, and then outputs a tilt amount data set (tilt angle detection signal) c6 to the correction device 92.

As shown in FIG. 2, the correction device 92 is configured using a personal computer or the like, and includes a tilt amount data receiving unit 93, a machine displacement amount calculating unit 94 and a correction amount calculating unit 95.

The tilt amount data receiving unit 93 receives the tilt amount data sets c1 to c6 of the structures (the column 53, the cross rail 54 and the saddle 56), which are outputted from the levels 61-1 to 61-6.

The machine displacement amount calculating unit 94 calculates the machine displacement amounts of the structures (the column 53, the cross rail 54 and the saddle 56) due to a tilt on the basis of the tilt amount data sets (tilt angle detection values) of the structures (the column 53, the cross rail 54 and the saddle 56), which are received by the tilt amount data receiving unit 93.

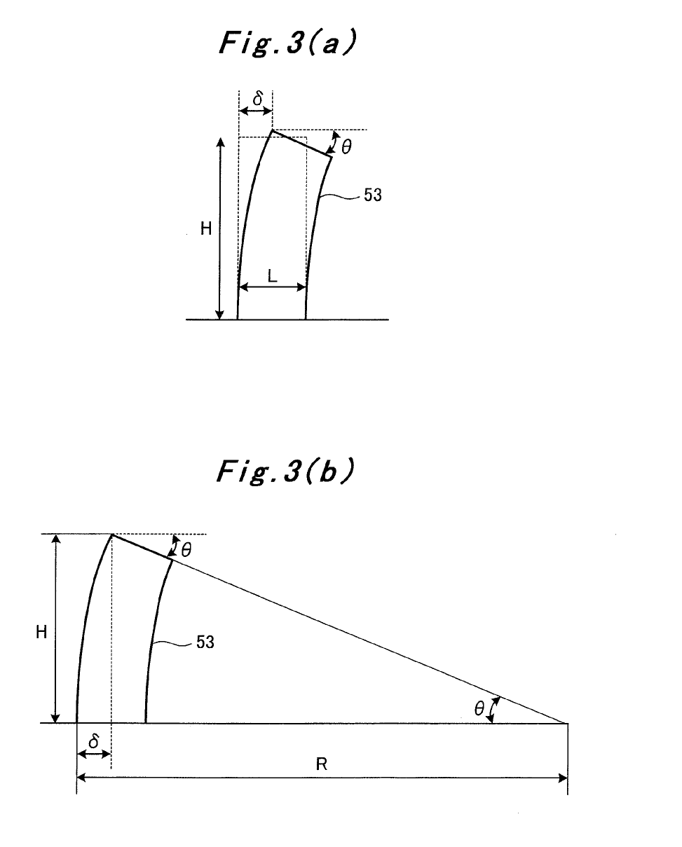

An example of calculating the machine displacement amount of the column 53 will be described on the basis of FIG. 3. In FIG. 3(a), H denotes the height [m] of the column 53, L denotes the width [m] of the column 53, and θ denotes the tilt angle [radian] of the column 53. In addition, a machine displacement amount δ of the column 53 is calculated by Equation (1) given below.

$$\begin{matrix}[ Equation 1 ] & \\ δ = H * \frac{θ}{2} & ( 1 )\end{matrix}$$

The derivation of Equation (1) is shown in FIG. 3(b). In a case where arc-shaped machine displacement as shown in FIG. 3(b) occurs on the column 53 due to warpage, a tilt or the like, the relationship between a radius R, the column displacement amount δ and the column height H is expressed by Equation (2) given below, where the radius of the arc is R. Moreover, Equation (1) is derived by transformation of Equation (2) into Equations (3), (4) and (5) given below.

$$\begin{matrix}[ Equation 2 ] & \\ {( R - δ )}^{2} + {H}^{2} = {R}^{2} & ( 2 ) \\ {R}^{2} - 2 R δ + {δ}^{2} + {H}^{2} = {R}^{2} & ( 3 ) \\ 2 R δ = {δ}^{2} + {H}^{2} \approx {H}^{2} & ( 4 ) \\ δ = \frac{{H}^{2}}{2 * R} = \frac{{H}^{2}}{2 * ( \frac{H}{θ} )} = \frac{H * θ}{2} & ( 5 )\end{matrix}$$

Note that the mean value between the tilt angle detection values (the tilt amount data sets c1, c2) from the two levels 61-1, 61-2 may be used for the column tilt angle θ used in Equation (1), or any one of the tilt angle detection values may be used for the column tilt angle θ used in Equation (1). Moreover, in a case where the column displacement amount δ of the intermediate height position of the column 53 is calculated, the tilt angle detection value (the tilt amount data set c3) from the level 61-3 is used for the column tilt angle θ. In a case where the displacement amount δ of the cross rail 54 is calculated, the mean value between the tilt angle detection values (the tilt amount data sets c4, c5) from the two levels 61-4, 61-5 may be used for the cross rail tilt angle θ, or any one of the tilt angle detection values may be used for the cross rail tilt angle θ. In a case where the displacement amount δ of the saddle 54 is calculated, the tilt angle detection value (the tilt amount data set c6) from the level 61-6 is used for the saddle tilt angle θ.

As shown in FIG. 2, the correction amount calculating unit 95 calculates the displacement amounts of the moving axes (the X-axis, the Y-axis and the Z-axis) on the basis of the machine displacement amounts of the structures (the column 53, the cross rail 54 and the saddle 56) calculated by the machine displacement amount calculating unit 94. The correction amount calculating unit 95 then sets the values of these displacement amounts with a reversed sign as the correction amounts of the moving axes (the X-axis, the Y-axis and the Z-axis), and sends the correction amounts to servo control devices 81, 82, 83 of the respective moving axes (the X-axis, the Y-axis and the Z-axis). To put it specifically, the correction amount of the X-axis (=“a minus displacement amount of the X-axis”) is sent to the servo control device 81 of the X-axis, the correction amount of the Y-axis (=“a minus displacement amount of the Y-axis”) is sent to the servo control device 82 of the Y-axis, and the correction amount of the Z-axis (=“a minus displacement amount of the Z-axis”) is sent to the servo control device 83 of the Z-axis. Note that a theoretical formula such as Equation (1) may be used to calculate the displacement amounts of the moving axes on the basis of the machine displacement amounts of the structures. Otherwise, it is also possible to use a calculation formula, table data or the like which represents the relationships between the machine displacement amounts of the structures and the displacement amounts of the moving axes previously found by testing or simulation, for example.

As shown in FIG. 2, a feeding mechanism 71 of the X-axis is includes a servomotor 74, reduction gears 75 and a ball screw 76 (screw unit 76a and nut unit 76b), and the like.

The servomotor 74 is connected to the screw unit 76a of the ball screw 76 via the reduction gears 75. The screw unit 76a and the nut unit 76b of the ball screw 76 are screwed together, and the nut unit 76b is attached to the table 52, which is a moving body. In addition, a position detector 77 is attached to the table 52, and a pulse coder 78 is attached to the servomotor 74.

Accordingly, when the screw unit 76a of the ball screw 76 rotates in a direction indicated with an arrow A upon transmission of the torque of the servomotor 74 to the screw unit 76a via the reduction gears 75, the table 52 moves in the X-axis direction together with the nut unit 76b. At this time, the position detector 77 detects the movement position of the table 52, and sends the position detection signal to the servo control device 81 of the X-axis (position feedback). In addition, the pulse coder 78 detects the rotation angle of the servomotor 74, and sends the rotation angle detection signal to the servo control device 81 via a differential operation unit 91 of the servo control device 81 (velocity feedback).

The servo control device 81 includes a deviation operation unit 84, a multiplier 85, a deviation operation unit 86, a proportional operation unit 87, an integral operation unit 88, an adder 89, a current controller 90, and the differential operation unit 91.

The deviation operation unit 84 corrects an X-axis position command, which is sent from a numerical controller (whose illustration is omitted), by adding the correction amount of the X-axis (=“a minus displacement amount of the X-axis”) sent from the correction device 92 (the correction amount calculating unit 95) to the X-axis position command, and finds a position deviation d1 by performing arithmetic on a difference between the corrected X-axis position command and the position of the table 52 that is the position feedback information from the position detector 77.

The multiplier 85 finds a velocity command d2 by multiplying the position deviation d1 by a position loop gain Kp. The differential operation unit 91 finds the rotation velocity of the servomotor 74 by differentiating, by time, the rotation angle of the servomotor 74 that is detected by the pulse coder 78. The deviation operation unit 86 finds a velocity deviation d3 by performing arithmetic on a difference between the velocity command d2 and the rotation velocity of the servomotor 74 that is found by the differential operation unit 86. The proportional operation unit 87 finds a proportional value d4 by multiplying the velocity deviation d3 by a velocity loop proportional gain Kv. The integral operation unit 88 finds an integral value d5 by multiplying the velocity deviation d3 by a velocity loop integral gain Kvi and then integrating this multiplied value. The adder 89 finds a torque command d6 by adding the proportional value d4 and the integral value d5. The current controller 90 controls the current to be supplied to the servomotor 74 in order for the torque of the servomotor 74 to follow the torque command d6.

Accordingly, the servo control device 81 of the X-axis performs control such that the rotation velocity of the servomotor 74 of the X-axis follows the velocity command d2 and the movement position of the table 52 in the X-axis direction follows the corrected X-axis position command.

Note that feeding mechanisms 72, 73 and the servo control devices 82, 83 of the Y-axis and the Z-axis are configured in the same manner as the feeding mechanism 71 and the servo control device 81 of the X-axis (the same reference numerals are given to the same component portions). Thus, no detailed description will be repeated herein.

In the servo control device 82 of the Y-axis, a deviation operation unit 84 corrects a Y-axis position command, which is sent from the numerical controller, by adding the correction amount of the Y-axis (=“a minus displacement amount of the Y-axis”) sent from the correction device 92 (the correction amount calculating unit 95) to the Y-axis position command, and thus finds a corrected Y-axis position command. Thereafter, the servo control device 82 performs control such that the rotation velocity of a servomotor 74 of the Y-axis follows the velocity command d2 and the movement position of the saddle 56 in the Y-axis direction follows the corrected Y-axis position command.

In the servo control device 83 of the Z-axis, a deviation operation unit 84 corrects a Z-axis position command, which is sent from the numerical controller, by adding the correction amount of the Z-axis (=“a minus displacement amount of the Z-axis”) sent from the correction device 92 (the correction amount calculating unit 95) to the Z-axis position command, and thus finds a corrected Z-axis position command. Thereafter, the servo control device 83 performs control such that the rotation velocity of a servomotor 74 of the Z-axis follows the velocity command d2 and the movement position of the ram 57 (the main spindle 58) in the Z-axis direction follows the corrected Z-axis position command.

When the structures (the column 53, the cross rail 54 and the saddle 56) of the machine tool are inclined due to the machine displacement (thermal displacement, self-weight displacement, or a combination of thermal displacement and self-weight displacement) such as warpage or a tilt, the foregoing configuration makes the machine displacement correction system for a machine tool according to the first embodiment capable of directly figuring out the tilt amounts (tilt angles) of the structures with the levels 61-1 to 61-6. Thus, the machine displacement correction system is capable of estimating the machine displacement amounts of the structures with high accuracy by calculating the machine displacement amounts of the structures (the column 53, the cross rail 54 and the saddle 56) on the basis of the tilt amount data sets c1 to c6 of the structures (the column 53, the cross rail 54 and the saddle 56), which are directly figured out with the levels 61-1 to 61-6. Accordingly, the machine displacement, correction system is capable of obtaining the correction amounts of the moving axes (the X-axis, the Y-axis and the Z-axis) with high accuracy on the basis of the machine displacement amounts. For this reason, a compensation system with high accuracy can be realized.

### Second Embodiment

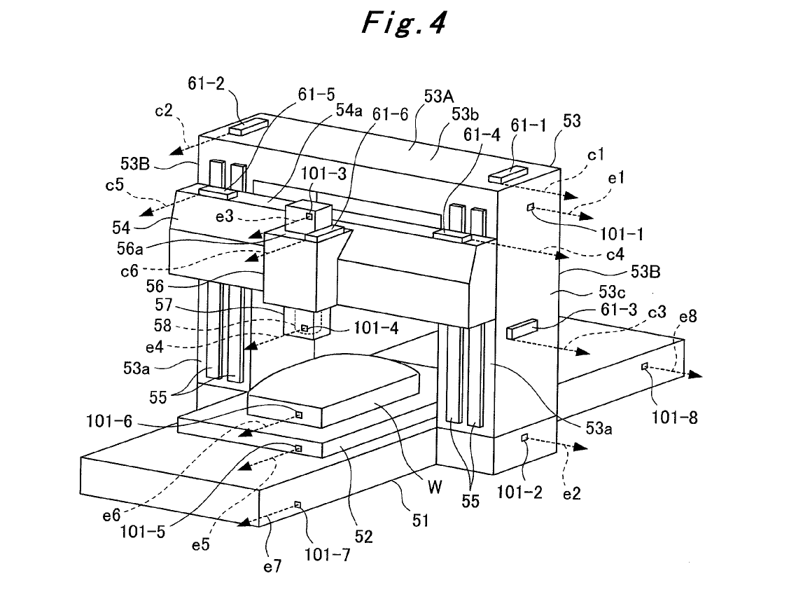

Descriptions will be provided for a machine displacement correction system using levels according to Embodiment 2 of the present invention on the basis of FIG. 4 to FIG. 6. Note that the same reference numerals are used to denote portions similar to those of the machine displacement correction system according to Embodiment 1 (refer to FIG. 1 and FIG. 2) in the machine displacement correction system according to the second embodiment, and no overlapping detailed description will be repeated herein.

As shown in FIG. 4, in the second embodiment, not only the digital levels 61-1 to 61-6 are installed to the machine tool (portal machining center) as in the case of the first embodiment, but also temperature sensors 101-1 to 101-8 are installed thereto.

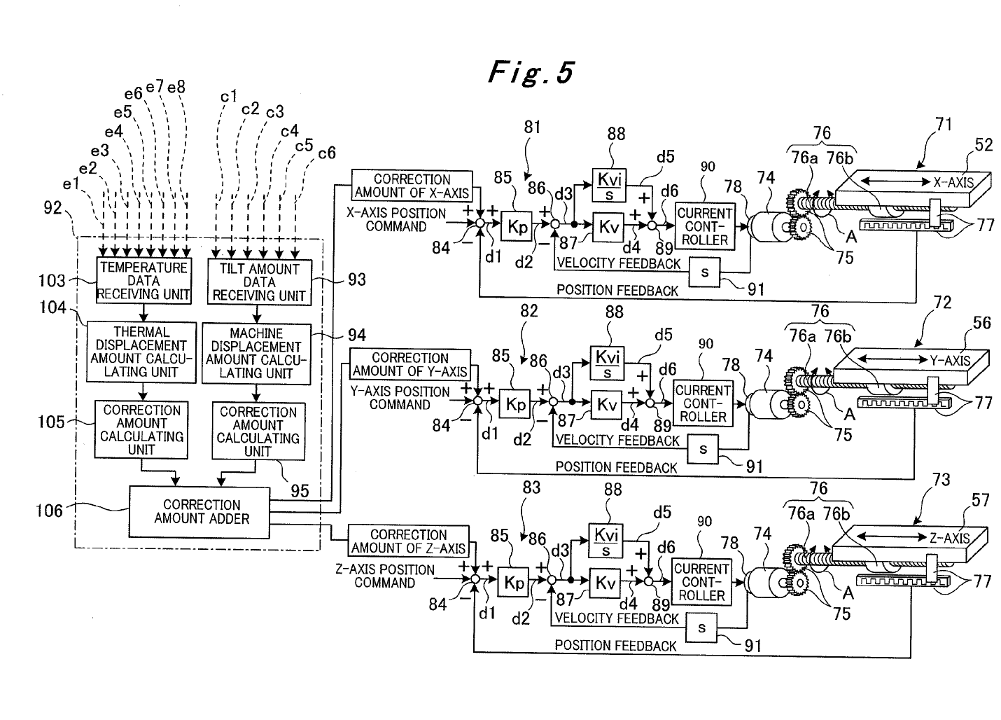

The temperature sensors 101-1, 101-2 are installed respectively at upper and lower portions of the side surface 53c of the column 53, as well as detect the temperatures of the column 53 and then output temperature data sets (temperature detection signals) e1, e2, respectively, to the correction device 92 (refer to FIG. 5: which will be described later in detail). The temperature sensors 101-3, 101-4 are installed respectively at upper and lower portions of the ram 57, as well as detect the temperatures of the ram 57 and then output temperature data sets (temperature detection signals) e3, e4 to the correction device 92. The temperature sensor 101-5 is installed to the table 52 and then detects the temperature of the table 53 and then output a temperature data set (temperature detection signal) e5 to the correction device 92. The temperature sensor 101-6 is installed to the workpiece W, as well as detects the temperature of the workpiece W and then outputs a temperature data set (temperature detection signal) e6 to the correction device 92. The temperature sensors 101-7, 101-8 are installed respectively at front and back portions of the bed 51, as well as detect the temperatures of the bed 51 and then output temperature data sets (temperature detection signals) e7, e8 to the correction device 92.

As shown in FIG. 5, the correction device 92 of Embodiment 2 includes not only the tilt amount data receiving unit 93, the machine displacement amount calculating unit 94 and the correction amount calculating unit 95 (first correction amount calculating unit) as in the case of the first embodiment, but also a temperature data receiving unit 103, a thermal displacement amount calculating unit 104, a correction amount calculating unit 105 (second correction amount calculating unit) and a correction amount adder 106.

The temperature data receiving unit 103 receives the temperature data sets e1 to e8 of the structures (the column 53, the ram 57, the table 52 and the bed 51) and the workpiece W, which are outputted from the temperature sensors 101-1 to 101-8.

The thermal displacement amount calculating unit 104 calculates the thermal displacement amounts of the structures (the column 53, the ram 57, the table 52 and the bed 51) and the workpiece W on the basis of the temperature data sets (temperature detection values) of the structures (the column 53, the ram 57, the table 52 and the bed 51) and the workpiece W, which are received by the temperature data receiving unit 103.

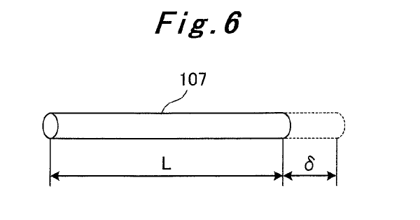

An example of calculating the thermal displacement amount of an object 107, which is equivalent to the column 53, the ram 57 or the like, will be described on the basis of FIG. 6. A thermal displacement amount (an amount of stretch due to heat) δ of the object 107 is calculated by Equation (6) given below. In FIG. 6 and Equation (6), L denotes the effective length [m] of the object 107, ΔT denotes the temperature change [° C.] (=T−T₀) of the object 107, and β denotes the linear expansion coefficient [m/° C.*m] of the object 107 (the displacement amount per meter [m] of the object 107 for each degree [° C.] in temperature change). In addition, T denotes the temperature [° C.] of the object 107, and Tₒ denotes a reference temperature [° C.] of the object 107.

σ=ΔT*L*β (6)

The temperature data sets e1 to e8 received from the temperature sensors 101-1 to 101-8 are used for the temperature T of the object 107. The reference temperature of the object 107 is previously set in the thermal displacement amount calculating unit 104. Note that the mean value between the temperature detection values (the temperature data sets e1, e2) from the two temperature sensors 101-1, 101-2 may be used as the temperature data set for calculating the thermal displacement amount of the column 53, or any one of the temperature detection values may be used as the temperature data set for calculating the thermal displacement amount of the column 53. Moreover, the mean value between the temperature detection values (the temperature data sets e3, e4) from the two temperature sensors 101-3, 101-4 may be used as the temperature data set for calculating the thermal displacement amount of the ram 57, or any one of the temperature detection values may be used as the temperature data set for calculating the thermal displacement amount of the ram 57. The temperature detection value (the temperature data set e5) from the temperature sensor 101-5 is used as the temperature data set for calculating the thermal displacement amount of the table 52. The temperature detection value (the temperature data set e6) from the temperature sensor 101-6 is used as the temperature data set for calculating the thermal displacement amount of the workpiece W. The mean value between the temperature detection values (the temperature data sets e7, e8) from the two temperature sensors 101-7, 101-8 may be used as the temperature data set for calculating the thermal displacement amount of the bed 51, or any one of the temperature detection values may be used as the temperature data set for calculating the thermal displacement amount of the bed 51.

As shown in FIG. 5, the correction amount calculating unit 105 calculates the displacement amounts of the moving axes (the X-axis, the Y-axis and the Z-axis) on the basis of the thermal displacement amounts of the structures (the column 53, the ram 57, the table 52 and the bed 51) and the workpiece W calculated by the thermal displacement amount calculating unit 104. The correction amount calculating unit 105 then sets the values of these displacement amounts with a reversed sign as the correction amounts of the moving axes (the X-axis, the Y-axis and the Z-axis). To put it differently, the correction amount calculating unit 105 finds the correction amount of the X-axis (=“a minus displacement amount of the X-axis”), the correction amount of the Y-axis (=“a minus displacement amount of the Y-axis”) and the correction amount of the Z-axis (=“a minus displacement amount of the Z-axis”). Note that a theoretical formula such as Equation (6) may be used to calculate the displacement amounts of the moving axes from the thermal displacement amounts of the structures. Otherwise, it is also possible to use a calculation formula, table data or the like which represents the relationships between the thermal displacement amounts of the structures and the displacement amounts of the moving axes previously found by testing or simulation, for example.

The correction amount adder 106 adds the correction amounts (the first correction amounts) of the respective moving axes (the X-axis, the Y-axis and the Z-axis) calculated by the correction amount calculating unit 95 and the correction amounts (the second correction amounts) of the respective moving axes (the X-axis, the Y-axis and the Z-axis) calculated by the correction amount calculating unit 105, as well as sends the addition values to the servo control devices 81, 82, 83 of the moving axes (the X-axis, the Y-axis and the Z-axis), respectively.

To put it differently, the correction amount of the X-axis to be sent to the servo control device 81 of the X-axis is the addition value of the first correction amount of the X-axis calculated by the first correction amount calculating unit 95 and the second correction amount of the X-axis calculated by the second correction amount calculating unit 105. The correction amount of the Y-axis to be sent to the servo control device 82 of the Y-axis is the addition value of the first correction amount of the Y-axis calculated by the first correction amount calculating unit 95 and the second correction amount of the Y-axis calculated by the second correction amount calculating unit 105. The correction amount of the Z-axis to be sent to the servo control device 83 of the Z-axis is the addition value of the first correction amount of the Z-axis calculated by the first correction amount calculating unit 95 and the second correction amount of the Z-axis calculated by the second correction amount calculating unit 105.

The deviation operation unit 84 of the servo control device 81 of the X-axis corrects an X-axis position command, which is sent from a numerical controller (whose illustration is omitted), by adding the correction amount of the X-axis (=“a minus displacement amount of the X-axis”) sent from the correction device 92 (the correction amount adder 106) to the X-axis position command, and finds a position deviation d1 by performing arithmetic on a difference between the corrected X-axis position command and the position of the table 52 that is the position feedback information from the position detector 77.

The deviation operation unit 84 of the servo control device 82 of the Y-axis corrects a Y-axis position command, which is sent from the numerical controller, by adding the correction amount of the Y-axis (=“a minus displacement amount of the Y-axis”) sent from the correction device 92 (the correction amount adder 106) to the Y-axis position command, and finds a position deviation d1 by performing arithmetic on a difference between the corrected Y-axis position command and the position of the saddle 56 that is the position feedback information from the position detector 77.

The deviation operation unit 84 of the servo control device 83 of the Z-axis corrects a Z-axis position command, which is sent from the numerical controller, by adding the correction amount of the Z-axis (=“a minus displacement amount of the Z-axis”) sent from the correction device 92 (the correction amount adder 106) to the Z-axis position command, and finds a position deviation d1 by performing arithmetic on a difference between the corrected Z-axis position command and the position of the ram 57 (the main spindle 58) that is the position feedback information from the position detector 77.

As in the case of the first embodiment, when the structures (the column 53, the cross rail 54 and the saddle 56) of the machine tool are inclined due to the machine displacement (thermal displacement, self-weight displacement, or a combination of thermal displacement and self-weight displacement) such as warpage or a tilt, the foregoing configuration makes the machine displacement correction system for a machine tool according to Embodiment 2 capable of directly figuring out the tilt amounts (tilt angles) of the structures with the levels 61-1 to 61-6. Thus, the machine displacement correction system is capable of estimating the machine displacement amounts of the structures with high accuracy by calculating the machine displacement amounts of the structures (the column 53, the cross rail 54 and the saddle 56) on the basis of the tilt amount data sets c1 to c6 of the structures (the column 53, the cross rail 54 and the saddle 56), which are directly figured out with the levels 61-1 to 61-6. Accordingly, the machine displacement correction system is capable of obtaining the first correction amounts of the moving axes (the X-axis, the Y-axis and the Z-axis) with high accuracy on the basis of the machine displacement amounts.

Moreover, the second embodiment can deal with not only the machine displacement such as warpage and a tilt, but also the thermal displacement such as stretch and the like of the structures (the column 53, the ram 57, the table 52, the bed 51) and the workpiece W due to heat, because of the addition of the second correction amounts of the moving axes (the X-axis, the Y-axis and the Z-axis), which are found on the basis of the temperature data sets e1 to e8 from the temperature sensors 101-1 to 101-8, to the first correction amounts of the moving axes (the X-axis, the Y-axis and the Z-axis). Accordingly, the second embodiment can obtain the correction amounts of the moving axes (the X-axis, the Y-axis and the Z-axis) with higher accuracy. Thus, a more highly-accurate compensation system can be realized.

Note that although the levels are used in Embodiments 1 and 2 described above, the tilt angle detectors do not always have to be the levels, and that tilt angle detectors other than the levels may be used as long as they are capable of directly detecting the tilt angles of the structures of the machine tool.

### INDUSTRIAL APPLICABILITY

The present invention relates to a machine displacement correction system for a machine tool, and is useful when applied to a case where machine displacement (thermal displacement, self-weight displacement and level displacement) occurring on a column and the like of a machine tool is corrected.

### EXPLANATION OF REFERENCE NUMERALS

51 bed, 52 table, 53 column, 53A horizontal portion, 53B leg portion, 53a front surface, 53b upper surface, 53c side surface, 54 cross rail, 54a upper surface, 55 guide rail, 56 saddle, 56a upper surface, 57 ram, 58 main spindle, 61-1 to 61-6 level, 71, 72, 73 feeding mechanism, 74 servomotor, 75 reduction gear, 76 ball screw, 76a screw unit, 76b nut unit, 77 position detector, 78 pulse coder, 81, 82, 83 servo control device, 84 deviation operation unit, 85 multiplier, 86 deviation operation unit, 87 proportional operation unit, 88 integral operation unit, 89 adder, 90 current controller, 91 differential operation unit, 92 correction device, 93 tilt amount data receiving unit, 94 machine displacement amount calculating unit, correction amount calculating unit, 101-1 to 101-8 temperature sensor, 103 temperature data receiving unit, 104 thermal displacement amount calculating unit, 105 correction amount calculating unit, 106 correction amount adder, c1 to c6 tilt amount data set (tilt angle detection signal), e1 to e8 temperature data set (temperature detection signal), W workpiece.

1. A machine displacement correction system configured to correct machine displacement of a machine tool, characterized in that
the system comprises:
a tilt angle detector installed to a structure of the machine tool, and configured to detect a tilt angle of the structure and to output tilt amount data; and
a correction device including:
a tilt amount data receiving unit configured to receive the tilt amount data from the tilt angle detector;
a machine displacement amount calculating unit configured to calculate a machine displacement amount of the structure on the basis of the tilt amount data received by the tilt amount data receiving unit; and
a correction amount calculating unit configured to calculate a correction amount of a moving axis of the machine tool on the basis of the machine displacement amount of the structure calculated by the machine displacement amount calculating unit.

2. A machine displacement correction system configured to correct machine displacement of a machine tool, characterized in that
the system comprises:
a tilt angle detector installed to a structure of the machine tool, and configured to detect a tilt angle of the structure and to output tilt amount data;
a temperature sensor installed to the structure of the machine tool or a workpiece, and configured to detect a temperature of the structure or the workpiece and to output temperature data; and
a correction device including:
a tilt amount data receiving unit configured to receive the tilt amount data from the tilt angle detector;
a machine displacement amount calculating unit configured to calculate a machine displacement amount of the structure on the basis of the tilt amount data received by the tilt amount data receiving unit;
a first correction amount calculating unit configured to calculate a first correction amount of a moving axis of the machine tool on the basis of the machine displacement amount of the structure calculated by the machine displacement amount calculating unit;
a temperature data receiving unit configured to receive the temperature data from the temperature sensor;
a thermal displacement amount calculating unit configured to calculate a thermal displacement amount of the structure or the workpiece on the basis of the temperature data received by the temperature data receiving unit;
a second correction amount calculating unit configured to calculate a second correction amount of the moving axis on the basis of the thermal displacement amount of the structure or the workpiece calculated by the thermal displacement amount calculating unit; and
a correction amount adder configured to add the first correction amount calculated by the first correction amount calculating unit and the second correction amount calculated by the second correction amount calculating unit.
